(19) United States
(12) Patent Application Publication
(10) Pub. No.: US 2019/0339429 A1
(43) Pub. Date: Nov. 7, 2019

(54) Safety Reflective Device

(71) Applicant: Ann Elizabeth Sterling, Clinton Township, MI (US)

(72) Inventor: Ann Elizabeth Sterling, Clinton Township, MI (US)

(21) Appl. No.: 16/512,088

(22) Filed: Jul. 15, 2019

(51) Int. Cl. G02B 5/12; B32B 7/06; B32B 7/12; B32B 25/06

(52) U.S. Cl. CPC G02B 5/12; B32B 7/06; B32B 7/12; B32B 2405/00; B32B 2307/712; B32B 2307/416; B32B 25/06

(57) ABSTRACT

The present invention is directed to a safety reflective device for domestic safety. The safety reflective device can be in the form of reflective strip and reflective decal, and can be produced in different shapes and sizes. The safety reflective device comprising a high intensity prismatic reflective layer and an ultra-strong adhesive layer adjacent to the prismatic reflective layer.

### FIELD OF INVENTION

The present invention relates to a safety reflector device, and in particular, relates to reflective strips and reflective decals for domestic safety.

### BACKGROUND

Accidents in low light or darkness are quite common. The reason for such accidents is the human eye under dark environment are unable to detect an object in their path. Even when a beam of light, such as a torch is used, the object may not reflect enough light to attract the attention of the human eye, thus causing a collision with the object. Children and pets are particularly susceptible to accidents in dark-environments.

Thus, a need is appreciated for a domestic safety device for children and pets.

### SUMMARY OF THE INVENTION

It is, therefore, a principal objective of the present invention to provide a safety reflective device adapted for domestic use.

An additional objective of the present invention is that the safety reflective device can be easily applied to a surface.

Still an additional objective of the present invention is that the safety reflective device is available in different shapes and colors.

A further objective of the present invention is that the safety reflective device is weather resistant.

Still a further objective of the present invention is that the safety reflective device is permanently bonded to a surface on which it is applied.

Yet another objective of the present invention is that the safety reflective device is economical to manufacture.

### BRIEF DESCRIPTION OF THE DRAWINGS

The accompanying figures, which are incorporated herein, form part of the specification and illustrate embodiments of the present invention. Together with the description, the figures further serve to explain the principles of the present invention and to enable a person skilled in the relevant arts to make and use the invention.

FIG. 1 shows the safety reflective device in form of paw, according to an embodiment of the present invention.

FIG. 2 shows the safety reflective device in form of star, according to an embodiment of the present invention.

FIG. 3 shows the safety reflective device in form of animal figure, according to an embodiment of the present invention.

### DETAILED DESCRIPTION

The present invention relates to a safety reflector device for domestic use, in particular a safety reflector device for children and pets.

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Certain embodiments of the present invention are directed to a safety reflection device which comprises a prismatic reflective layer. The prismatic reflective layer is a high-intensity grade gloss reflective layer which can be seen easily from 100 feet. The unique prismatic construction provides an extra high level of reflectivity for domestic safety. The prismatic reflective material according to the present invention meets all other requirements set forth in ASTM D 4956 including Shrinkage, Flexibility, Liner removal, Adhesion, Impact resistance, specular gloss, and Outdoor weathering (Types III and IV). The edges of safety reflection device especially laterally—can be rounded for safety. The prismatic reflective layer can be adapted to reflect light of different colors.

In another embodiment, the safety reflection device comprises an adhesive layer adjacent to the prismatic reflective layer for adhering the safety reflection device to a surface. The adhesive is an ultra-strong commercial adhesive for long lasting adhering. The adhesive forms an aggressive bond with the surface on which the safety reflection device is applied. The strong adhesive according to the present invention provide durability to reflective strips or reflective decals, and the reflective strips or decals doesn't wear off or tear-off with time. The adhesive has excellent resistance to weathering and salt water. Moreover, the adhesive has excellent plasticizer migration and moisture resistance. The adhesive is dimensionally stable. In one case, the adhesive is acrylate-based.

The safety reflective device of the present invention also includes a release liner which protects the exposed surface of the adhesive layer. The release liner also extends on one or both ends beyond the actual length of the safety reflector device to provide tabs which enable easy removal of the release liner. The extended portion of the release liner provides a handle allowing the release liner to be pulled away from the adhesive layer. The shape of the extended portion is such that to provide a substantial handle for a user's hand, thereby eliminating the need for any tools when removing the release liner. The extending portion also prevents contamination and damage to the adhesive during handling and application. The extended portion of the release liner can be made thicker than the portion coming in contact with the adhesive layer to provide robust handling. Moreover, the entire release liner can be made thicker to provide a more robust handle. The release liner is removed just before adhering the safety reflective device to a surface. This allows maximum protection of the adhesive layer. In one case, the release liner can be paper-based. In another case, the release liner can be polyester based.

In one embodiment, the safety reflective device is adapted in the form of reflective strips. The reflective strips including the prismatic reflective layer, the pressure sensitive adhesive layer adjacent to the prismatic reflective layer and the release liner protecting the pressure sensitive adhesive layer. In use, the release liner is removed and the reflective strip is applied to a surface at the adhesive layer. Thereafter, pressure can be applied over the prismatic reflective layer to firmly adhere to the surface. Optionally, the reflective strip may further comprise a protective layer. The protective layer is used to protect the prismatic reflective layer from any damage during handling and storage. For example, the protective layer protects the prismatic reflective layer from any scratches during handling or storage. In one case, the protective layer may be permanently bonded to the prismatic reflective layer. It is obvious that the protective layer is transparent, and does not affect the reflectivity of light by the prismatic reflective layer. The length of the protective layer may be same or slightly more than the prismatic reflective layer. In another case, the protective layer is removably adhere to the prismatic reflective layer. The protective layer can be removed after adhering the reflective strip to the surface. Like the release liner, the protective layer may also be provided with an extended portion forming a handle. The protective liner is preferably clear so that the user can easily see through it to properly register the reflective strip onto the surface.

In an alternate embodiment, the safety reflective device can be adapted in the form of a reflective decal. The reflective decal includes the prismatic reflective layer, the adhesive layer adjacent to the prismatic reflective layer, a release liner removably adhered onto the adhesive layer and a backing layer removably adhered to the prismatic reflective layer. The backing liner is preferably clear so that the user can easily see through it to properly register the reflective decal onto a surface. In use, the release liner is removed and the reflective decal is applied onto the surface. Sufficient pressure may be applied over the backing layer to firmly adhere to the surface. Thereafter, the backing layer can be removed. The backing layer may also have an extending portion forming a handle.

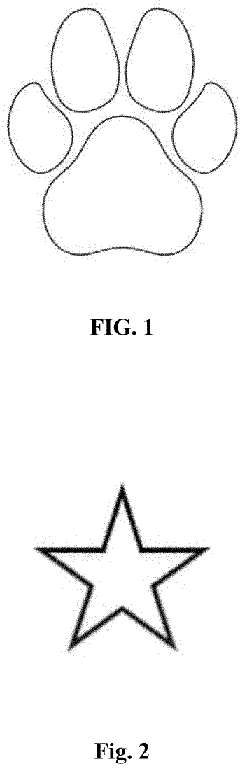

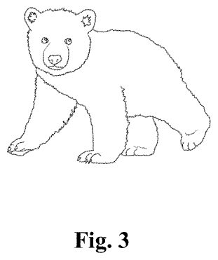

The safety reflector device may be provided in different shapes and colors. For example, FIG. 1-3 shows the safety reflector device in the form of a paw (FIG. 1), a star (FIG. 2) and animal figures (FIG. 3). In one case, the safety reflector device can be adapted to various objects, for example, the reflector strips can be shaped for application to a pet harness or clothing. Similarly, the reflector strips can be designed for backpacks, helmets, skateboards and like. The safety reflective devices can also be used on mailbox and garbage cans.

In another embodiment, a kit is provided which includes safety reflector device of different shapes and color. For example, the kit can include the reflector strip and the reflective decal. The kit, in one case, can be customized for cycling wherein the kit includes reflector strips for helmet and bicycle. In another case, the kit may comprise reflector strips for skates and backpack. The reflector strips for the backpack can be in the form of an animal figure, while the reflector strip for skates can be longitudinal.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A safety reflector strip comprising:
a prismatic reflective layer; and
a pressure sensitive adhesive layer adjacent to the prismatic reflective layer.

2. The safety reflector strip of claim 1, wherein the safety reflector strip further comprises a release liner removably coupled on the pressure sensitive adhesive layer.

3. The safety reflector strip of claim 1, wherein the safety reflector strip is star shaped.

4. The safety reflector strip of claim 1, wherein the safety reflector strip is animal figure shaped.

5. The safety reflector strip of claim 1, wherein the safety reflector strip is paw shaped.

6. The safety reflector strip of claim 1, wherein the safety reflector strip have smooth edges.

7. The safety reflector strip of claim 1, wherein the safety reflector strip is weather resistant.

8. The safety reflector strip of claim 1, wherein the pressure sensitive adhesive makes a permanent bond to a surface over which the safety reflector strip is applied.

9. A safety decal comprising:
a prismatic reflective layer; and
an adhesive layer adjacent to the prismatic reflective layer.

10. The safety decal of claim 9, wherein the safety decal further comprises a release liner removable adhered on the adhesive layer, and a backing layer removably adhered on the prismatic adhesive layer.

11. The safety decal of claim 9, wherein the safety decal is star shaped.

12. The safety decal of claim 9, wherein the safety decal is animal figure shaped.

13. The safety decal of claim 9, wherein the safety decal is paw shaped.

14. The safety decal of claim 9, wherein the adhesive is acrylate based.

15. The safety decal of claim 9, wherein the safety decal is weather resistant.

16. The safety decal of claim 9, wherein the adhesive makes a permanent bond to a surface over which the safety decal is applied.

17. A kit comprising a safety reflector strip and a safety decal, the safety reflector strip
comprising:
a prismatic reflective layer;
a pressure sensitive adhesive layer adjacent to the prismatic reflective layer; and
a release liner removably adhered on the pressure sensitive adhesive layer;
the safety decal comprising:
a prismatic reflective layer;
an acrylate based adhesive layer adjacent to the prismatic reflective layer;
a second release liner removably adhered on the adhesive layer; and
a backing layer removably adhered on the prismatic reflective layer.
